(19) United States
(12) Patent Application Publication
(10) Pub. No.: US 2025/0176582 A1
(43) Pub. Date: Jun. 5, 2025

(54) CONFECTIONERY

(71) Applicant: SOCIETE DES PRODUITS NESTLE S.A., Vevey (CH)

(72) Inventor: BEATRICE KUSCHEL, York (GB)

(21) Appl. No.: 18/843,362

(22) PCT Filed: Mar. 3, 2023
(86) PCT No.: PCT/EP2023/055509

§ 371 Date: Sep. 3, 2024

(30) Foreign Application Priority Data
Mar. 4, 2022 (EP) 22160252.7

(51) Int. Cl. A23G 1/46; A23C 9/12; A23G 1/40

(52) U.S. Cl. CPC A23G 1/46; A23C 9/1203; A23G 1/40

(57) ABSTRACT

The present invention relates to milk-based confectionery comprising an oligosaccharide mixture.

### FIELD OF THE INVENTION

The present invention relates to a chocolate product comprising an oligosaccharide mixture, which is derived from milk.

### BACKGROUND OF THE INVENTION

Any discussion of the prior art throughout the specification should in no way be considered as an admission that such prior art is widely known or forms part of common general knowledge in the field.

The increasing interest in reduced sugar intake in the diet by health conscious consumers has led to a strong demand for food products with lower sugars. Sugar, however, is a key food ingredient that in addition to imparting natural sweetness to food products also functions to provide bulk and therefore plays a significant role in the structure, volume and mouthfeel of the finished food product.

Sugar is a naturally occurring sweetener that as aforementioned provides the sweetness in food products that consumers crave but is also highly calorific and so there is an important need for healthier, non-caloric or low-caloric sweetener alternatives. There have been many approaches that are well known in the art, involving the replacement or reduction of sugars in food products, such as using artificial sweeteners to replace natural sugar.

Thus, it is generally well known to those skilled in the art of food manufacturing that replacing or reducing sugar in a food composition usually negatively impacts the flavour, and other taste components. For instance, sugar replacers may be slower in onset of the sweetness perception and longer in duration compared to natural sugar and so therefore change the taste balance of a food composition.

In addition, sugar replacers may not deliver as sweet a taste as natural sugar and may also exhibit metallic, cooling, astringent, liquorice-like, and bitter after tastes.

In a further example, applying the prior art solutions as aforementioned for fat based confectionery products may also result in similar disadvantages. For instance, using bulking agents such as certain fibres in chocolate compositions usually leads to bitter aftertastes and adds undesirable bulk to the mixture, resulting in an increase in the viscosity of the mixture. This in turn makes it difficult to carry out the standard post-processing of the mixture such as enrobing and moulding which are essential steps towards furnishing a finished chocolate product.

Additionally, sugar provides certain sensory and perception properties to products that are very hard to replicate with the above-mentioned sugar replacers. Hence, whilst the calorie content is reduced, the eating experience is often worsened. Proposed routes to overcome these issues often involve an increase in fat content, which offsets the potential health benefits.

Moreover, in milk-based confectionery, milk itself contains sugar, i.e. lactose. This also contributes to the sugar content of confectionery where milk is present. It is known to reduce the lactose content of milk using enzymes, for example. Indeed, lactose-free chocolate is also available. However, in order to compensate for the loss of lactose, it is generally necessary to substantially increase the fat content and/or introduce other bulking agents, which, in turn, impact the processing, nutritional value and organoleptic properties of the confectionery, as discussed above.

There thus remains the problem of providing low calorie or reduced sugar alternative confectionery products without having a detrimental impact on the sweetness perception and/or any of the above associated problems of the prior art solutions.

Accordingly, there remains a need to find low calorie sugar replacers that can be used in a chocolate products, which avoids the problems of loss or reduction in sweetness, bitter aftertastes and off-flavours and maintain organoleptic properties.

These issues are further exacerbated when attempting to provide low sugar chocolate, specifically less than 5 g/100 g under the regulatory provisions in most countries. The provision of such chocolates has not been previously achieved with any degree of commercial success.

It is an object of the present invention to ameliorate at least one disadvantage of the prior art as aforementioned of previous reduced or low calorie confectionery alternatives.

### SUMMARY OF THE INVENTION

Accordingly, this need is solved by the features of the independent claims. The dependent claims further develop the central idea of the invention.

Thus, in a first aspect, the present invention relates to a chocolate product comprising:
a. a milk product comprising a carbohydrate mixture, wherein the milk product is present in an amount of between 0.5 wt % and 50 wt % of the chocolate product and the milk product comprises between 10 wt % and 90 wt % carbohydrate mixture based on the weight of the milk product, wherein the carbohydrate mixture comprises between 10 wt % and 100 wt % galacto-oligosaccharides, and
b. a polyol present in an amount of between 30 wt % and 65 wt % of the chocolate product.

Accordingly, the carbohydrate mixture may be used to replace sugar (e.g. sucrose), milk-based ingredients (e.g. skimmed milk powder) and combinations thereof in a chocolate product. Additionally, the polyol material may be used to replace sugar (e.g. sucrose) in a chocolate product.

In a preferred embodiment, the carbohydrate mixture is prepared from a milk-substrate using an enzyme that has transglycosylation activity.

It has been surprisingly found by the inventors that the combination of a carbohydrate mixture derived from a milk product and a polyol can be used to replace sugar (such as sucrose) and/or milk-based ingredients in a confectionery product without having a detrimental effect on the sweetness of the food product and also the organoleptic properties of the product, as well as not impacting the processing conditions for manufacture. This is a key advantage of the present invention, the reduction in sugar content without any loss in organoleptic properties, for example, no associated significant “clagginess” (i.e. stickiness or tackiness). This is a very surprising result as even reduced sugar chocolates are often not palatable but the present invention can provide a low or zero sugar chocolate.

### DETAILED DESCRIPTION OF THE INVENTION AND THE PREFERRED EMBODIMENTS

As mentioned above, the present invention provides a chocolate product comprising:
a. a milk product comprising a carbohydrate mixture, wherein the milk product is present in an amount of between 0.5 wt % and 50 wt % of the chocolate product and the milk product comprises between 10 wt % and 90 wt % carbohydrate mixture based on the weight of the milk product, wherein the carbohydrate mixture comprises between 10 wt % and 100 wt % galacto-oligosaccharide, and
b. a polyol present in an amount of between 30 wt % and 65 wt % of the chocolate

In a preferred embodiment, the chocolate product comprises at least 0.05 wt %, at least 0.5 wt %, at least 2.5 wt %, or at least 5.0 wt % of the carbohydrate mixture on a dry weight basis based on the weight of the chocolate product.

In a preferred embodiment, the chocolate product comprises less than 45%, less than 40.0 wt %, less than 30 wt %, less than 25.0 wt %, less than 20.0 wt % or less than 10 wt % of the carbohydrate mixture on a dry weight basis based on the weight of the chocolate product. For example, between 0.5 wt % and 45 wt %, between 2.5 wt % and 20 wt %.

In a preferred embodiment, the chocolate product contains non-carbohydrate milk solids (e.g. fat and protein) in an amount of greater than 0 wt %, at least 1.0%, at least 2.5%, at least 5.0%, at least 10.0%, at least 12.5% or at least 15.0% of the non-carbohydrate milk solids on a dry weight basis based on the weight of the chocolate product.

In a preferred embodiment, the chocolate product comprises less than 35.0 wt %, less than 32.5%, less than 30.0%, less than 27.5%, less than 25.0%, or less than 20.0% of the non-carbohydrate milk solids on a dry weight basis based on the weight of the chocolate product. For example, at least 1.0% and less than 32.5%.

Preferably, the carbohydrate mixture is obtained by treating a milk product with an enzyme that has transglycosylation activity, e.g. a mechanism for glycosidic link formation, particularly during oligosaccharide and/or polysaccharide synthesis.

In a preferred embodiment, the carbohydrate mixture and non-carbohydrate milk solids are from the same origin. In a preferred embodiment, the carbohydrate mixture is derived from treating a milk product with an enzyme that has transglycosylation activity.

In a preferred embodiment, the milk product is a skimmed milk. The skimmed milk may have a fat content below 1.5% on a dry weight basis, for example below 1.2%.

The milk powder particles for use in the invention may have a moisture content between 0.5 and 6%, for example between 1 and 5%, for further example between 1.5 and 3%. The moisture content of the milk powder may be measured using known techniques, e.g. Karl Fischer.

Preferred aspects of the invention are described in more detail below.

### Oligosaccharide Compositions and Milk Product

The invention preferably uses a mixture of carbohydrates as an ingredient in a chocolate product. The carbohydrate mixture comprises oligosaccharides.

In an embodiment, the chocolate product may contain carbohydrates from other sources, e.g. sucrose. Accordingly, in an embodiment, the present invention encompasses compositions where a carbohydrate mixture within the scope of the claim set is present irrespective of other carbohydrates present.

The term ‘oligosaccharide’ means a saccharide oligomer containing a small number (typically two to ten) of component monosaccharides.

Specifically, oligosaccharides (OS) are herein defined as those found naturally in animal milks and/or those synthetically produced and having a degree of polymerisation (DP) ranging from 2 to 20. The term ‘synthetic’ means a process of chemical and/or biological (e.g. enzymes) means. These oligosaccharides may be soluble in milk. The invention utilises an oligosaccharide mixture, preferably derived from cow's milk, wherein the mixture has a lactose:to non-lactose oligosaccharides weight ratio of less than 20:1, more preferably less than 10:1, more preferably less than 5:1, more preferably less than 1:1, more preferably less than 1:5, more preferably less than 1:10 and more preferably less than 1:20. In an embodiment, the mixture used corresponds to a 4 to 200 times decreased lactose content in the oligosaccharide mixture as compared to the original milk, which is equivalent to a 4 to 200 times increased ratio between oligosaccharides and lactose.

The carbohydrate mixture for use in the invention contains galacto-oligosaccharides (GOS), preferably comprising β-GOS and/or α-GOS and mixtures of such linkages in the GOS, preferably resulting from the action of an enzyme, preferably one having transglycosylation activity, preferably also acting as a 3-galactosidase, mainly on lactose and optionally also, but to a much lesser extent, on some of the soluble oligosaccharides present in the milk.

In a preferred embodiment, therefore, the GOS result from the action of the β-galactosidase on lactose and on milk OS. The enzyme is preferably added during the production of the OS mixture. The enzyme preferably has a twofold activity: it breaks down lactose into the monosaccharides, galactose and glucose and, secondly, via a transferase activity, it catalyses the subsequent formation of GOS. These oligosaccharides are preferably made from glucose and galactose monomers, having a DP of from 2 to 10, preferably from 3 to 10 or preferably from 2 to 6 and preferably have a prebiotic activity.

In a preferred embodiment, the GOS used in in the carbohydrate mixture of the present invention as the following composition (DP degree of polymerization, all % by weight based on the wt % of DP2-6 measured using the method described in the examples):
a DP2 of between 20% and 40%, preferably between 25% and 35%, preferably between 27.5% and 32.5%;
a DP3 of between 25%, and 55%, preferably between 30% and 50%, preferably between 35% and 45%;
a DP4 of between 7.5% and 27.5%, preferably between 12.5% and 22.5%, preferably between 15% and 20%;
a DP5 of between 2.5% and 15%, preferably between 3% and 12.5%, preferably between 4% and 10%; and
a DP6 2.6% of between 0% and 10%, preferably between 1% and 5%, preferably between 1.5% and 4%.

In a preferred embodiment, the above DP2 content does not contain lactose, as is clear from the known definition of GOS.

Alternatively, the carbohydrate mixture may be prepared from individual components or commercially available sources that match the profile required by the present invention. For example, Bimuno® GOS. In this case, if non-carbohydrate milk solids are also required to be present, they can be provided, for example, by lactose-free skimmed milk powder or milk protein concentrate. The commercially available GOS may need further processing, e.g. drying, dependent on form to be used in chocolate-products.

The OS profile may be characterised by HPLC, Mass Spectrometry and other methods. According to a preferred HPLC method, the OS present in the samples are extracted in water at 70° C. The extracted OS are fluorescently labeled by reaction (2 h at 65° C.) of 2-anthranilic acid amide via formation of a Schiff's base. The double bond is then reduced by reaction with sodium cyanoborohydride to give a stable oligosaccharide aminobenzide (OS-AB) derivative. Labelled extracts are diluted with acetonitrile prior to injection on a HPLC-fluorimeter instrument equipped with a trapping column. Separation is performed on Amide-80 3 μm, 4.6×150 mm column, and labeled OS are detected on a fluorimeter at: Ex 330 nm, Em 420 nm. Quantification of the different OS is performed by calibration of the OS-2AB response with maltotriose external standard and using laminaritriose as internal standard.

In a preferred embodiment, at most 40 wt % of the carbohydrates in the mixture is lactose, preferably at most 30 wt %, and preferably at most 20 wt % based on the weight of the mixture of carbohydrates. In another preferred embodiment, 0-30 wt %, preferably 0-20 wt %, of the total carbohydrates in the carbohydrate mixture is lactose.

For example, in an embodiment, at most 15 wt % or at most 10 wt % of the total carbohydrates in the mixture is lactose. In another embodiment, from 0 wt % to 15 wt % or 2 wt % to 10 wt % of the total carbohydrates in the mixture is lactose.

In an embodiment, the carbohydrate mixture for use in the invention comprises DP2+ (degree of polymerisation of 2 or more, i.e. 2 or more saccharide units), preferably DP3+, GOS in an amount of at least 20 wt % of the total carbohydrate mixture.

In a preferred embodiment, at least 25 wt % of the total carbohydrates is DP2+, preferably DP3+, GOS, preferably at least 30 wt %, preferably at least 35 wt %, preferably at least 40 wt % or preferably at least 45 wt %.

Accordingly, in a preferred embodiment, the carbohydrate mixture comprises GOS in an amount of 10-80 wt % of the carbohydrate mixture and 20-80 wt % of the total carbohydrates are DP2+, preferably DP3+, GOS.

In the present invention, 10-100 wt %, preferably 20-95 wt %, preferably 20-90 wt %, preferably 20-80 wt %, preferably 30-70 wt %, of the carbohydrate mixture is GOS.

In an embodiment, the amount of GOS may be obtained using the AOAC 2001.02 method or by the method described in International Journal of Analytical Chemistry, Volume 2014, Article ID 768406, Austin et. al.

In an embodiment, the present invention utilises a carbohydrate mixture, which has the following carbohydrate composition expressed as dry matter percentage by weight of the mixture:
a. Lactose 0-40%
b. Glucose 0-40%
c. Galactose 0-40%
d. GOS 10-100%, preferably 10-80%.

In an embodiment, the present invention utilises a carbohydrate mixture, which has the following carbohydrate composition expressed as dry matter percentage by weight of the mixture:
a. Lactose 2-30%
b. Glucose 5-30%
c. Galactose 0-20%
d. GOS 30-80%.

In an embodiment, the present invention utilises a carbohydrate mixture, which has the following carbohydrate composition expressed as dry matter percentage by weight of the mixture:
a. Lactose 3-20%
b. Glucose 10-30%
C. Galactose 1-10%
d. GOS 45-70%.

In an embodiment, the present invention utilises a carbohydrate mixture, which has the following carbohydrate composition expressed as dry matter percentage by weight of the mixture:
a. Lactose 3-15%
b. Glucose 10-25%
C. Galactose 1-5%
d. GOS 50-70%.

In an embodiment, the present invention utilises a carbohydrate mixture, which has the following carbohydrate composition expressed as dry matter percentage by weight of the mixture:
a. Lactose 0-10%
b. Glucose 10-30%
C. Galactose 0-10%
d. GOS 45-90%.

It will be appreciated that the above amounts cannot exceed 100%, and the amount of one or more of the components a. to d. must be varied to ensure that the total amount does not exceed 100%, e.g. if component d. is 70%, component b. can only be 30% in the embodiments where a. and c. may be 0%. Additionally, in an embodiment, the amounts of a. to d. equal 100%.

In an embodiment, the mixture has a moisture content of less than 5%, preferably between 0.5% and 5% (for example between 2% and 3%). This may be measured by Karl Fischer methods.

As mentioned above, the carbohydrate mixtures for use in the present invention may be prepared from a milk product. Accordingly, the milk product for use in the invention may be concentrated milk, such as condensed milk, or spray-dried concentrated milk. In a preferred embodiment, the milk product is milk powder, preferably skimmed milk powder.

In an embodiment, the chocolate product comprises greater than and not including 0 wt % of the milk product comprising the carbohydrate mixture based on the weight of the chocolate product, preferably greater than 0.5 wt %, preferably greater than 2 wt %, preferably greater than 5 wt %, preferably greater than 7 wt %, preferably greater than 10 wt %.

In an embodiment, the chocolate product comprises less than 50 wt % of the milk product comprising the carbohydrate mixture based on the weight of the chocolate product, preferably less than 40 wt %, preferably less than 35 wt %, preferably less than 30 wt %, preferably less than 25 wt %, less than 22 wt % or less than 20 wt %.

In a preferred embodiment, preferably for milk chocolate, the chocolate product comprises between 2 wt % and 25 wt % of the milk product, preferably between 5 wt % and 22 w %, more preferably between 7 wt % and 20 wt % and most preferably between 10 wt % and 17 wt %.

In a further preferred embodiment, preferably for white chocolate, the chocolate product comprises between 15 wt % and 50 wt % of the milk product, preferably between 25 wt % and 45 wt %, and more preferably between 30 wt % and 40 wt % and most preferably between 30 wt % and 35 wt %.

The milk product comprises greater than 10 wt % of the carbohydrate mixture by weight of the milk product, preferably greater than 15 wt %, preferably greater than 20 wt %, preferably greater than 30 wt % and preferably greater than 40 wt %.

The milk product comprises less than 90 wt %, preferably less than 80 wt %, preferably less than 70 wt %, preferably less than 60 wt % and preferably less than 55 wt % of the carbohydrate mixture by weight of the milk product. For example, between 15 wt % and 80 wt %, 20 wt % and 70 wt % and 30 wt % and 60 wt %.

Hence, in a highly preferred embodiment, the present invention provides a chocolate product:
comprising a milk product in an amount of between 5 wt % and 40 wt %, preferably between 7 wt % and 30 wt %, and
the milk product comprises between 30 wt % and 70 wt % based on the weight of the milk product of the carbohydrate mixture of the present invention, preferably between 40 wt % and 55 wt %, and the carbohydrate mixture comprises between 20 wt % and 80 wt % GOS.

It is noted that in an embodiment, the carbohydrate mixture is derived from lactose present in the milk product. It is noted that lactose contents of full fat milk may be approximately between 35 wt % and 40 wt % of the solid content and for skimmed milk powder approximately between 45 wt % and 55 wt %. The treatment of the present invention converts this lactose to a carbohydrate mixture, i.e. does not create mass. However, using known techniques, other solid components (e.g. fat and protein) may be removed from the milk product to relatively increase the amount of carbohydrate mixture.

In an embodiment, the treated, preferably enzyme treated, milk product for use in the invention comprises at least 5 wt % of DP2+, preferably DP3+, GOS based on the weight of the milk product. In a preferred embodiment, the milk product comprises a total amount of at least 10 wt %, preferably at least 15 wt %, preferably at least 20 wt % and preferably at least 25 wt %.

In a preferred embodiment, the milk product comprises 5-60 wt %, preferably 10-50 wt % or 15-45 wt %, of DP2+, preferably DP3+, GOS based on the weight of the milk product.

In a preferred embodiment, the milk product preferably comprises a total amount of at most 20 wt %, preferably at most 10 wt %, preferably at most 5 wt %, lactose based on the weight of the milk product. The lactose content of the milk product may be determined by AOAC 930.28 (2000).

In a preferred embodiment, at most 50 wt % of the total carbohydrates in the milk product is lactose, preferably at most 30 wt %, preferably at most 20 wt % and more preferably at most 15 wt %. In another preferred embodiment, 0-30 wt %, preferably 0-20 wt % and more preferably 0-10 wt %, of the total carbohydrates in the milk product is lactose.

In another embodiment, at most 15 wt % or at most 12 wt % of the total free carbohydrates in the milk product is lactose. In another embodiment, 0-15 wt % or 2-12 wt % of the total free carbohydrates in the milk product is lactose.

In a preferred embodiment of the present invention, the milk product is milk powder, preferably skimmed milk powder, comprising a total amount of at least 10 wt % of DP2+, preferably DP3+, GOS by weight of the milk powder, preferably at least 15 wt %, more preferably at least 20 wt %.

In a preferred embodiment of the present invention, the milk product is milk powder, preferably skimmed milk powder, comprising a total amount of 10-50 wt % of DP2+, preferably DP3+, GOS by weight of the milk powder, preferably 15-45 wt % or 15-40 wt %, more preferably 20-40 wt %.

In an embodiment, the present invention utilises a milk product, which has the following carbohydrate composition expressed as dry matter weight percentage of the milk product:
a. Lactose 0-20%
b. Glucose 0-30%
c. Galactose 0-10%
d. GOS 5-60%.

In an embodiment, the present invention utilises a milk product, which has the following carbohydrate composition expressed as dry matter weight percentage of the milk product:
a. Lactose 2-15%
b. Glucose 5-20%
C. Galactose 0-7.5%
d. GOS 10-50%.

In an embodiment, the present invention utilises a milk product, which has the following carbohydrate composition expressed as dry matter weight percentage of the milk product:
a. Lactose 3-10%
b. Glucose 7.5-15%
c. Galactose 1-5%
d. GOSs 15-45%.

In the above embodiments, preferably the remainder of the milk product is non-carbohydrate milk solids (e.g. fat and protein) to total 100 wt % of the milk product.

In embodiments of the present invention, it will be appreciated that a sum of the above amounts cannot exceed the total amount of the carbohydrate mixture present in the milk powder nor can they exceed 100% of the milk powder.

In the above embodiments, the amount of carbohydrate mixture in the milk product and the amount of milk product in the chocolate product is selected so that the carbohydrate mixture is present in an amount greater than and not including 0 wt % and less than or equal to 35 wt % of the chocolate product.

As mentioned above, the carbohydrate composition and/or the milk product is preferably in the form of powder, preferably they have a particle size that is comparable to standard milk powders. Accordingly, in a preferred embodiment, the carbohydrate composition and/or the milk product has a d90 value of between 100 and 300 microns, preferably between 150 and 250 microns. In a further preferred embodiment, the carbohydrate composition and/or the milk product has a d10 value of between 10 and 75 microns, preferably between 15 and 60 microns. The term dX is a diameter where X % of the volume of the particles in the sample have a diameter below that value (volume weighted distribution). Preferably, laser diffraction is used to measure the particle size, d90 or d10 using a Malvern Mastersizer 2000, Method Scirocco 2000 dry attachment, Fraunhofer scattering theory. These particle sizes may be modified in chocolate manufacture, for example, as described below in respect of refining.

In an embodiment, the milk product for use in the present invention has optionally been subjected to treatments known in the art, for example, pasteurization, demineralisation, filtration, for example, ESL treatment or UHT treatment.

In a preferred embodiment, the present invention provides a chocolate product comprising:
a milk product comprising a carbohydrate mixture in an amount of between 10 wt % and 90 wt % of the milk product,
the milk product is present in an amount of between 0.5 wt % and 50 wt % of the chocolate product,
wherein the amount of carbohydrate mixture in the milk product and the amount of milk product in the chocolate product is selected so that the carbohydrate mixture is present in an amount of between 0.45 wt % and less than or equal to 35 wt % of the chocolate product, and
the carbohydrate mixture comprises GOS in an amount of 10-100 wt %, preferably 10-80 wt %, of the carbohydrate mixture.

### Carbohydrate Mixture Production

The invention preferably utilises a method for producing a milk product, which comprises:
(a) providing a milk substrate comprising a total solids content of between 40 wt % and 75 wt %, preferably wherein the milk substrate comprises at least 15 wt % lactose based on a dry solids content;
(b) treating the milk substrate with an enzyme having transglycosylation activity, and
(c) optionally fully or partially inactivating the enzyme.

In a preferred embodiment, the milk substrate is used to provide a milk product comprising the carbohydrate mixture used in the invention.

In a method of the present invention, a milk product is produced from a milk substrate by contacting the milk substrate comprising lactose with a transglycosylation enzyme which converts lactose in the milk substrate to GOS.

The milk substrate to be used in the method is based on milk. The term ‘milk’, in the context of the present invention, is to be understood as the aqueous, lactose, protein and fat-based secretion obtained by milking any mammal, such as cows, sheep, or goats.

In one embodiment, the milk substrate is obtained from milk which has been modified in composition by adjustment of fat content, protein content, lactose content and/or water content. Adjustment of fat content and/or water may have been done by any method known in the art, e.g., by centrifugation, evaporation, condensation, ultrafiltration, nanofiltration, freeze-drying, spray-drying, reconstitution by addition of water, etc. Example methods are given, for example in ‘The Technology of Dairy Products’, edited by Ralph Early.

In an embodiment, the milk substrate comprises at least 40 wt %, preferably at least 45 wt %, at least 50 wt %, at least 55 wt %, at least 57 wt %, or at least 60 wt %, total solids.

In a preferred embodiment, the total solids content of the milk substrate is less than 75 wt %, preferably less than 70 wt % and preferably less than 60 wt %.

In a preferred embodiment, the milk substrate is reconstituted milk powder, such as reconstituted skimmed milk powder, or concentrated milk, such as condensed milk, which comprises at least 40 wt %, preferably at least 45 wt %, at least 50 wt %, at least 55 wt %, at least 57 wt %, or at least 60 wt % total solids.

The milk substrate preferably comprises at least 15 wt % lactose based on a dry matter percentage of the solids present in the substrate. In a preferred embodiment, the milk substrate comprises at least 20 wt %, preferably at least 25 wt % or at least 30 wt %.

In a preferred embodiment, the milk substrate is contacted with the enzyme for at least 15 minutes, preferably for at least 45 minutes, preferably for at least 55 minutes, preferably for at least 1 hour, preferably at least 1.5 hours, or at least 3 hours. In an embodiment, the contacting time is less than 15 hours, preferably less than 10 hours or less than 5 hours.

In a preferred embodiment, the milk substrate is contacted with the enzyme at a temperature of at least 35° C., preferably at least 40° C., preferably at least 45° C., or at least 50° C. In a preferred embodiment, the milk substrate is contacted with the enzyme at a temperature of equal to less than 75° C.

In a preferred embodiment, the milk substrate is contacted with an enzyme at a temperature of between 35° C. and 75° C., for 45 minutes to 10 hours, preferably 2-5 hours.

In a preferred embodiment, the enzyme is added in an amount of between 0.05% and 10% by weight of the lactose content, for example between 0.1% and 7.5% by weight or between 0.25% and 5% by weight.

The enzyme for use in the present invention is preferably one with 8-galactosidase activity.

The enzyme for use in the present invention is preferably one that catalyses the transfer of a mono-, di- or oligosaccharide entity onto a mono-, di- or oligosaccharide substrate resulting in the formation of saccharide-entities of 2 or more subunits connected through glycoside link(s). In a preferred embodiment, the enzyme has transglycosylation activity.

One enzyme may be used or a mixture of more than one enzyme may be used in the present invention.

Specifically, the enzyme is preferably a glycosidase (EC. 3.2.1), preferably a β-Galactosidase (EC. 3.2.1.23) or Lactase (EC. 3.2.1.108), catalysing the transgalactosylation reaction of a D-galactose moiety, a lactose molecule or a GOS (Galactooligosaccharide) onto a D-galactose moiety obtained from lactose by a preceeding 1^{st} step of disconnection reaction of the glycosidic link of lactose catalysed by the same enzyme.

Such enzymes are commercially available, e.g. Maxilact A4® (DSM), GODO-YNL 2® (DuPont), Lactozyme® etc. The enzyme may be used in any format, e.g. liquid, paste or powder.

Hence, in an embodiment, the enzyme having transglycosylation activity is added at a concentration of 11,000 U per g lactose, preferably 5-500 U per g lactose, more preferably 8-150 U per g lactose, whereby 1 U is defined as the amount of the enzyme that catalyzes the conversion of one micromole of lactose per minute under the specified conditions of an assay method. The activity in U of a specific enzyme may be determined by direct measurement of the formation of GOS from the lactose. The assay method preferably being a 60% (w/v) skimmed milk powder solution in water, at 60° C. for 60 minutes. Preferably, 1 U is the amount of enzyme that will catalyze the conversion of one micromole of lactose per minute under the aforementioned conditions. Preferably, 1 U enzyme will catalyse 0.342 mg per minute in a 60% (w/v) skimmed milk powder solution in water, at 60° C. for 60 minutes. The activity in U of a specific enzyme may be determined by direct measurement of the formation of GOS from the lactose using a method such as liquid chromatography.

After the treatment period, the enzyme is preferably fully or partly inactivated. The enzyme may be inactivated by any state of the art method, for example, by heat treatment, pH lowering (e.g. to below pH 4) or lowering water activity. The inactivation may occur due to a step in the production process of the milk product or the chocolate product, preferably in pasteurization or spray-drying.

In a preferred embodiment, the enzyme is fully or partly inactivated by heat treatment, preferably at between 75° C. and 100° C. for between 3 and 15 minutes.

In a preferred embodiment, after enzyme treatment, the milk product obtained may be further processed by methods known in the art, preferably pasteurization, homogenisation and/or drying, preferably spray-drying.

In a preferred embodiment, the solution prepared by steps (a) to (c) is dried to provide a solid for combination with other ingredients of the chocolate product.

In an alternative embodiment it is plausible that other known procedures may be used to carry out the process of the present invention for example, foam drying, freeze drying, tray drying, fluid bed drying, vacuum drying and the like.

In an embodiment, the carbohydrate mixture may be provided by combining the individual components in the required amounts.

In a preferred embodiment, the carbohydrate mixture may be combined with other components of milk to provide an alternative source of the milk product. For example, in an embodiment, the milk product is prepared by combining a carbohydrate mixture prepared by individual component combination with a milk protein concentrate.

In this embodiment, the total wt % of milk product in the chocolate product is the sum of the milk protein concentrate and the carbohydrate mixture.

In an embodiment, the milk protein concentrate may be present at an amount of between 5 wt % and 30 wt % of the chocolate product, preferably between 7.5 wt % and 25 wt % and preferably between 10 wt % and 20 wt %.

In an embodiment, the above amounts of milk protein concentrate are equally applicable to the protein contents of milk products prepared by the method of the present invention.

### Polyols

In the present invention, a polyol is present in an amount of between 30 wt % and 65 wt % of the chocolate product.

In a preferred embodiment, the polyol is present in an amount of between 35 and 60 wt %, more preferably between 41 and 56 wt %, more preferably between 42 and 53 wt % and more preferably between 45 and 50 wt %.

According to the present invention the polyol is a sugar alcohol preferably selected from the group comprising isomalt, sorbitol, maltitol, mannitol, xylitol, erythritol, threitiol, arabitol, lactitol, galactitol and hydrogenated starch hydrolysates and mixtures thereof.

In a highly preferred embodiment, the polyol is maltitol.

### PREFERRED EMBODIMENTS

Preferred embodiments of the chocolate product of the present invention comprise the following ingredient combinations of the materials defined above (all percentages are by weight of the chocolate product unless otherwise specified):
a) the milk product between 5 wt % and 22 wt %
b) the polyol between 35 wt % and 60 wt %.
a) the milk product between 7 wt % and 20 wt %
b) the polyol between 41 wt % and 56 wt %.
a) the milk product between 10 wt % and 17 wt %
b) the polyol between 45 wt % and 50 wt %.

In highly preferred embodiments, the polyol in the above embodiments is maltitol.

In highly preferred embodiments, the milk product comprises between 20 wt % and 70 wt % of the milk product of the carbohydrate mixture and the carbohydrate mixture comprises between 20 wt % and 80 wt % of the carbohydrate mixture of GOS.

### Chocolate Products and Materials

The present invention relates to chocolate products that contain ingredients derived from milk, where the milk product comprises the carbohydrates as discussed above.

As is clear from the above, in a preferred embodiment, the carbohydrate mixture of the present invention is derived from a milk product that is typically used in a confectionery. Accordingly, in an embodiment, the treated milk product or corresponding components (e.g. milk protein concentrate, GOS etc.) are added to the chocolate product to at least partially replace the milk ingredient of the chocolate product. Accordingly, in an embodiment, the replacement is between 10 wt % and 100 wt % of non-fat milk solids in the chocolate product, preferably between 25 wt % and 100 wt %, preferably between 50 wt % and 100 wt %, preferably between 75 wt % and 100 wt % of the non-fat milk solids.

In an embodiment, the chocolate product, of the present invention comprises cocoa butter (or equivalent as described below) by weight of the chocolate product in at least 5.0% by weight, preferably at least 10.0% by weight, preferably at least 13.0% by weight, more preferably at least 15.0% by weight, for example at least 17.0% or at least 20%.

The preferred maximum amount of cocoa butter (or equivalent as described below) present in the chocolate product of the present invention is less than 50.0 wt % or less than 40.0% by weight, preferably not more than 35.0% by weight, more preferably not more than 30.0% by weight, and most preferably not more than 25.0% cocoa butter by weight of the chocolate product. For example, between 0.0 wt % and 35.0 wt % or 10.0 wt % and 35.0 wt % of the chocolate product.

In an embodiment, the cocoa butter (CB) may be replaced at least partially by cocoa butter equivalents (CBE), cocoa butter replacers (CBR) and/or cocoa butter substitutes (CBS). Such products may generally comprise one or more fat(s) selected from the group consisting of: lauric fat(s) (e.g. cocoa butter substitute (CBS) obtained from the kernel of the fruit of palm trees); non-lauric vegetable fat(s) (e.g. those based on palm or other specialty fats); cocoa butter replacer(s) (CBR); cocoa butter equivalent(s) (CBE) and/or any suitable mixture(s) thereof. Some CBE, CBR and especially CBS may contain primarily saturated fats and very low levels of unsaturated omega three and omega six fatty acids (with health benefits). Thus, in one embodiment in chocolate product confectionery of the invention such types of fat are less preferred than CB.

In an embodiment, the chocolate product comprises between 0% and 95% by weight of the chocolate product of cocoa mass dependent on the end product, preferably between 0% and 85%, for example, between 45% and 80%, less than 5% or between 8% and 20% by weight of the chocolate product of cocoa mass.

Generally, the chocolate product of the present invention comprises at least 5.0 wt %, preferably at least 10.0 wt %, preferably at least 13.0 wt %, at least 15.0 wt %, and or at least 17.0 wt % cocoa mass of the chocolate product.

The preferred maximum amount of cocoa mass present in the chocolate product of the present invention is less than 35.0 wt %, preferably not more than 30.0 wt %, and most preferably not more than 25.0 wt % cocoa mass. For example, between 5.0 wt % and 35.0 wt % of the chocolate product.

If the chocolate product is a white chocolate product, the amount of cocoa mass is lower than that above, preferably not present. The cocoa mass may be partially or fully replaced by the milk product for use in the present invention.

In an embodiment, the fat based chocolate product, preferably chocolate compositions, of the present invention comprises at least 1.0 wt %, preferably at least 1.3 wt %, more preferably at least 1.5 wt %, and even more preferably at least 1.7 wt % milk fat of the chocolate product.

The preferred maximum amount of milk fat present in the fat based chocolate product, preferably chocolate compositions, of the present invention is less than 10.0 wt %, preferably not more than 7.5 wt %, more preferably not more than 6.0 wt %, and most preferably not more than 5.0 wt % milk fat of the chocolate product. For example, between 1.0 wt % and 10.0 wt % of the chocolate product.

The milk fat may be added separately to the composition and/or be present in any milk-based product added, e.g. milk powder. In a preferred embodiment, the milk fat is present in the milk product obtained by enzyme treatment, as described above, and is also added separately.

According to the present invention the term sugar as used herein refers to as is conventionally understood a sweet crystalline substance obtained from various plants, especially sugar cane and sugar beet, and used as a sweetener in food and drink. In the context of the present invention sugar is defined as and includes all mono, di and oligo-saccharides, preferably mono- and di-saccharides, for example sucrose, fructose, glucose, dextrose, galactose, allulose, maltose, high dextrose equivalent hydrolysed starch syrup, xylose, and combinations thereof.

Accordingly, the sugar used within the invention may be selected from the group consisting of sucrose, fructose, glucose, dextrose, galactose, allulose, maltose, high dextrose equivalent hydrolysed starch syrup, xylose, and any combinations thereof.

In the present invention, the aim is to reduce the sugar content of the chocolate product, however, the chocolate product may still contain sugar (e.g. sugar not derived from the milk solids). In a preferred embodiment, the chocolate product comprises less than 40.0 wt % sugar, preferably less than 35.0 wt %, preferably less than 30.0 wt %, preferably less than 25.0 wt %, preferably less than 20 wt %, and preferably less than 15.0 wt %. For example, between 0.0 wt % and 40.0 wt % or between 5.0 wt % and 40.0 wt % or between 10.0 wt % and 40.0 wt %, preferably between 0.0 wt % and 20.0 wt %, and preferably between 0.0 wt % and 15.0 wt %.

In a highly preferred embodiment, the total sugar content is below 10 wt % of the chocolate product, preferably between 0.0 wt % and 8.5 wt %, and more preferably between 0.0 wt % and 8.0%, for example, between 0.1 wt % and 7.5 wt %

In a preferred embodiment, fat content of the chocolate product is greater than 15 wt % of the chocolate product, greater than 20 wt %, or greater than 25 wt %.

In a preferred embodiment, fat content of the chocolate product is less than 45 wt % of the chocolate product, less than 40 wt %, less than 35 wt % or less than 30 wt %. For example, between 15 wt % and 45 wt %.

A preferred chocolate product of the invention, has a total sugar content of between 0.0 wt % and 8.5 wt % and fat content of between 15 wt % and 40 wt %, both based on the weight of the chocolate product.

According to the present invention, the chocolate product is prepared according to conventional chocolate product making processes as will be well known and obvious to a person skilled in the art.

Additionally, the present invention provides a method of manufacturing a chocolate product comprising the carbohydrate mixture described above, the method comprising mixing the carbohydrate mixture described above with fat and optionally ingredients selected from the group consisting of cocoa liquor/mass, crystalline sugar, lecithin and combinations of these; refining the resulting mixture to reduce the particle size of the components; and mixing the refined mixture with further fat and optionally lecithin and liquefying.

The fat may for example be cocoa butter, cocoa butter equivalent or cocoa butter replacer. The fat may be cocoa butter. Some or all of the milk powder, cocoa liquor and crystalline sugar may be replaced by chocolate crumb. In a preferred embodiment, the liquefaction is carried out by conventional means well known to a person skilled in the art and refers to conching, a standard process in chocolate manufacture. In a preferred embodiment, 15% to 30% of the total fat present after liquefying is used in the final step.

In an embodiment, the chocolate composition of the present invention may be refined using known equipment as applicable. In a preferred embodiment, the chocolate is refined to ensure a non-grainy texture. For example, the refining may be carried out to achieve a particle size (D90 measured by a Malvern Mastersizer 3000) of less than 50 microns, preferably between 15 microns and 35 microns. Preferably a Malvern Mastersizer 2000, Method Scirocco 2000 dry attachment, Fraunhofer scattering theory is used.

In an embodiment, the traditional conching process is used to prepare the chocolate. In a preferred embodiment, the temperature in the conching step does not exceed 60° C., preferably does not exceed 57.5° C. and preferably does not exceed 56° C. By controlling the temperature during this step, degradation of the carbohydrate mixture is avoided and the texture of the final product is not grainy nor is taste impacted. In a preferred embodiment, the temperature is greater than 30° C., preferably greater than 35° C. or greater 40° C. or greater than 45° C.

In an embodiment, the conching is carried out for a period of greater than 1.5 hours, preferably greater than or equal to 2 hours, preferably greater than or equal to 2.5 hours. In an embodiment, the conching is carried out for a period of less than 8 hours, preferably less than 6 hours.

In an embodiment, the conching is carried out for a period of between 1.5 hours and 8 hours at a temperature between 30° C. and 60° C.

In an embodiment, the conching speed is between 200 rpm and 2000 rpm, preferably between 400 rpm and 1600 rpm. This may be varied across the conching process.

### General Definitions

In an embodiment, compositions of the invention may usefully be chocolate products (as defined herein), more usefully be chocolate or a chocolate compound. Independent of any other legal definitions that may be used compositions of the invention that comprises a cocoa solids content of from 25 wt % to 35 wt % together with a milk ingredient (such as milk powder) may be informally referred to herein as ‘milk chocolate’ (which term also encompasses other analogous chocolate products, with similar amounts of cocoa-solids or replacements therefor). Independent of any other legal definitions that may be used compositions of the invention that comprises a cocoa solids content of more than 35 wt % (up to 100% (i.e. pure cocoa solids) may be informally referred to herein as ‘dark chocolate’ (which term also encompasses other analogous chocolate products, with similar amounts of cocoa-solids or replacements therefor)).

The term ‘chocolate’ as used herein denotes any product (and/or component thereof if it would be a product) that meets a legal definition of chocolate in any jurisdiction and also include product (and/or component thereof) in which all or part of the cocoa butter (CB) is replaced by cocoa butter equivalents (CBE) and/or cocoa butter replacers (CBR).

The term ‘chocolate compound’ as used herein (unless the context clearly indicates otherwise) denote chocolate-like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids.

The term ‘chocolate product’ as used herein denote chocolate, compound and other related materials that comprise cocoa butter (CB), cocoa butter equivalents (CBE), cocoa butter replacers (CBR) and/or cocoa butter substitutes (CBS). Thus, chocolate product includes products that are based on chocolate and/or chocolate analogues, and thus for example may be based on dark, milk or white chocolate.

In an embodiment, the chocolate product composition comprises:
8-12% of cocoa mass
30-60% of polyol, preferably maltitol
18-25% of cocoa butter
3.5-6.5% of milk fat
5-22% of the milk product of the present invention
0.3-0.5 of lecithin

In an embodiment, the chocolate product composition comprises:
30-60% of polyol, preferably maltitol
18-24% non-fat milk solids
4-7% of milk fat
22-35% of (optionally deodorised) cocoa butter
20-40% of the milk product of the present invention
0.2-0.5 of lecithin

Unless the context clearly indicates otherwise, it will also be appreciated that in the present invention, any one chocolate product may be used to replace any other chocolate product and neither the term chocolate nor compound should be considered as limiting the scope of the invention to a specific type of chocolate product. Preferred chocolate product comprises chocolate and/or compound, more preferred chocolate product comprises chocolate, most preferred chocolate product comprises chocolate as legally defined in a major jurisdiction (such as Brazil, EU and/or US).

The chocolate product of the invention may be used to mould a tablet and/or bar, to coat confectionery items and/or to prepare more complex confectionery products. Optionally, prior to its use in the preparation of a chocolate product confectionery product, inclusions according to the desired recipe may be added to the chocolate product. As it will be apparent to a person skilled in the art, in some instances the product of the invention will have the same recipe and ingredients as the corresponding composition and/or mass while in other instances, particularly where inclusions are added or for more complex products, the final recipe of the product may differ from that of the composition and/or mass used to prepare it.

In one strongly preferred embodiment of the invention, the chocolate product confectionery product comprises a substantially solid moulded chocolate tablet, chocolate bar and/or baked product surrounded by substantial amounts of chocolate product. These products are prepared for example by substantially filling a mould with chocolate product and optionally adding inclusions and/or baked product therein to displace chocolate product from the mould (so-called wet shelling processes), if necessary further topping up the mould with chocolate product. For such strongly preferred products of the invention the chocolate product forms a substantial or whole part of the product and/or a thick outside layer surrounding the interior baked product (such as a wafer and/or biscuit laminate). Such solid products where a mould is substantially filled with chocolate are to be contrasted with products that comprise moulded thin chocolate shells which present different challenges.

Preferred chocolate product confectionery may comprise one or more ingredients, for example selected from the group consisting of: chocolate product(s), compound product(s), chocolate coating(s) and/or compound coating(s). The products may comprise uncoated products such as chocolate bar(s) and/or chocolate tablets(s) with or without inclusions and/or products coated with chocolate product such as coated biscuits, cakes, wafers and/or other confectionery items. More preferably and/or alternatively any of the aforementioned may comprise one or more cocoa butter replacer(s) (CBR), cocoa-butter equivalent(s) (CBE), cocoa-butter substitute(s) (CBS) and/or any suitable mixture(s) thereof.

In chocolate product confectionery, the cocoa butter (CB) may be replaced by fats from other sources. Such products may generally comprise one or more fat(s) selected from the group consisting of: lauric fat(s) (e.g. cocoa butter substitute (CBS) obtained from the kernel of the fruit of palm trees); non-lauric vegetable fat(s) (e.g. those based on palm or other specialty fats); cocoa butter replacer(s) (CBR); cocoa butter equivalent(s) (CBE) and/or any suitable mixture(s) thereof. Some CBE, CBR and especially CBS may contain primarily saturated fats and very low levels of unsaturated omega three and omega six fatty acids (with health benefits). Thus in one embodiment in chocolate product confectionery of the invention such types of fat are less preferred than CB.

One embodiment of the invention provides a multi-layer product optionally comprising a plurality of layers of baked foodstuff (preferably selected from one or more wafer and/or biscuit layers, and/or one or more fillings layers there between) with at least one coating layer located around these layers foodstuff, the coating comprising a chocolate product of or prepared according to the invention.

A further embodiment of the invention provides a chocolate product confectionery product, further coated with chocolate (or equivalents thereof, such as compound) for example a praline, chocolate shell product and/or chocolate coated wafer or biscuit any of which may or may not be layered. The chocolate coating can be applied or created by any suitable means, such as enrobing or moulding. The coating may comprise a chocolate product of or prepared according to the invention.

In another preferred embodiment of the invention the foodstuff comprises a multi-layer coated chocolate product comprising a plurality of layers of wafer, chocolate product, biscuit and/or baked foodstuff, with filling sandwiched between them, with at least one layer or coating being a chocolate product (e.g. chocolate) of the invention. Most preferably the multi-layer product comprises a chocolate product confectionery product (e.g. as described herein) selected from sandwich biscuit(s), cookie(s), wafer(s), muffin(s), extruded snack(s) and/or praline(s). An example of such a product is a multilayer laminate of baked wafer and/or biscuit layers sandwiched with filling(s) and coated with chocolate.

In the discussion of the invention herein, unless stated to the contrary, the disclosure of alternative values for the upper and lower limit of the permitted range of a parameter coupled with an indicated that one of said values is more preferred than the other, is to be construed as an implied statement that each intermediate value of said parameter, lying between the more preferred and less preferred of said alternatives is itself preferred to said less preferred value and also to each less preferred value and said intermediate value.

For all upper and/or lower boundaries of any parameters given herein, the boundary value is included in the value for each parameter unless stated otherwise, i.e. ‘less than’ means ‘less than and including’ and ‘greater than’ means ‘greater than and including’ but ‘less than and not including’ means the boundary value is not included. It will also be understood that all combinations of preferred and/or intermediate minimum and maximum boundary values of the parameters described herein in various embodiments of the invention may also be used to define alternative ranges for each parameter for various other embodiments and/or preferences of the invention whether or not the combination of such values has been specifically disclosed herein.

Unless otherwise specified % in the present description correspond to wt %.

It will be understood that the total sum of any quantities expressed herein as percentages cannot (allowing for rounding errors) exceed 100%. For example, the sum of all components of which the composition of the invention (or part(s) thereof) comprises may, when expressed as a weight (or other) percentage of the composition (or the same part(s) thereof), total 100% allowing for rounding errors. However, where a list of components is non exhaustive the sum of the percentage for each of such components may be less than 100% to allow a certain percentage for additional amount(s) of any additional component(s) that may not be explicitly described herein.

The term ‘substantially’ (or ‘essentially’) as used herein may refer to a quantity or entity to imply a large amount or proportion thereof. Where it is relevant in the context in which it is used ‘substantially’ can be understood to mean quantitatively (in relation to whatever quantity or entity to which it refers in the context of the description) there comprises an proportion of at least 80%, preferably at least 85%, more preferably at least 90%, most preferably at least 95%, especially at least 98%, for example about 100% of the relevant whole. By analogy the term ‘substantially-free’ or ‘free’ may similarly denote that quantity or entity to which it refers comprises no more than 20%, preferably no more than 15%, more preferably no more than 10%, most preferably no more than 5%, especially no more than 2%, for example about 0% of the relevant whole.

The term ‘comprising’ as used herein will be understood to mean that the list following is non exhaustive and may or may not include any other additional suitable items, for example one or more further feature(s), component(s), ingredient(s) and/or substituent(s) as appropriate. Thus the words ‘comprise’, ‘comprising’ and the like are to be construed in an inclusive sense as opposed to an exclusive or exhaustive sense; that is to say, in the sense of ‘including, but not limited to’. It should be noted that embodiments and features described in the context of one of the aspects of the present invention also apply to the other aspects of the invention.

The invention will now be described in further details in the following non-limiting examples. The following examples are provided for illustrative purposes only and they are not to be considered in any way limiting to the scope of the present invention.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### EXPERIMENTAL SECTION

### Examples

The following examples are illustrative of the products and methods of making the same falling within the scope of the present invention. They are not to be considered in any way limitative of the invention. Changes and modifications can be made with respect to the invention. That is the skilled person will recognise many possible variations in these examples covering a wide range of compositions, ingredients, processing methods and mixtures and can adjust the naturally occurring levels of the compounds of the invention for a variety of applications.

### Preparatory Example 1

Skimmed milk powder is reconstituted at total solids content of 55-60% and heated to 45° C. for 20 minutes. An enzyme is contacted with the milk substrate for 60° C. and 1 hour. The enzyme is deactivated and the solution pasteurized using 80° C. for 10 minutes. Homogenization is then carried out and the solution spray dried to form a powder. The enzymes used were Maxilact® A4 from DSM.

In Example 1, the enzyme was used at 3.2 wt % of the lactose content of the skimmed milk powder.

In Example 1 the GOS yield was 26 wt % of the carbohydrate mixture. The GOS yield was measured according to AOAC 2001.02.

### Examples 1 to 3 and Reference Examples 1 to 3

Chocolate compositions were made to the following recipes to test the scope of chocolate production using this invention (wt %):

| Ingredient | Reference 1 | Reference 2 | Reference 3 | Example 1 | Example 2 | Example 3 |
|---|---|---|---|---|---|---|
| Sugar | 43.85 | 34.32 | 34.32 | | | |
| Maltitol | | | | 48.6 | 41.0 | 55.7 |
| Cocoa | 16.05 | 16 | 16 | 18.6 | 18.6 | 18.6 |
| butter | | | | | | |
| Skimmed | 15.49 | 31.52 | | | | |
| milk | | | | | | |
| powder | | | | | | |
| Lactose | | | 31.52 | | | |
| free SMP | | | | | | |
| Milk | | | | 13.9 | 21.5 | 5.0 |
| product | | | | | | |
| comprising | | | | | | |
| GOS | | | | | | |
| Cocoa | 13.4 | 13.4 | 13.4 | 13.0 | 13.0 | 13.0 |
| mass | | | | | | |
| Milk fat | 4.43 | 4.2 | 4.2 | 5.4 | 5.4 | 7.2 |
| Whey | 6.22 | | | | | |
| powder | | | | | | |
| Lecithin | 0.51 | 0.51 | 0.51 | 0.50 | 0.5 | 0.5 |
| Total Sugar | 52.4 | 51.6 | 34.3 | 3.5 | 5.0 | 1.7 |
| Total Fat | | | | 31.6 | 31.6 | 33.3 |

The milk product contained 32.0 GOS %, 5.3 lactose %, 53.0 carbohydrate %, 36.3 protein % and 0.9 fat %. It was prepared by the method of Preparatory Example 1.

The chocolates were manufactured using a standard technique with the maltitol and milk product being added at the stage where sucrose and milk powder are traditionally added.

An informal tasting with a panel of 10 tasters was carried out. Example 1 was perceived as surprisingly flavoursome, sweet and smooth—more so than a comparable chocolate made using skimmed milk powder (Reference 2). Moreover, some tasters found Example 1 to be indistinguishable from the full-sugar reference using sucrose (Reference 1). Surprisingly, the cooling effect expected to arise from the use of a polyol such as Maltitol was less noticeable than expected in Example 1. These results are highly surprising for such low sugar products.

### Reference Example 1

A commercially available GOS source from Clasado was analysed using the method of International Journal of Analytical Chemistry, Volume 2014, Article ID 768406 and provided the following saccharide distribution (wt %), DP2 32.8%, DP3 39.3%, DP4 17.9%, DP5 7.4% and DP6 2.6% based on the DP2-6 content. Such a GOS source may be used in the carbohydrate mixture of the present invention.

1. A chocolate product comprising:
a. a milk product comprising a carbohydrate mixture, wherein the milk product is present in an amount of between 0.5 wt % and 50 wt % of the chocolate product and the milk product comprises between 10 wt % and 90 wt % carbohydrate mixture based on the weight of the milk product, wherein the carbohydrate mixture comprises between 10 wt % and 100 wt % galactooligosaccharide, and
b. a polyol present in an amount of between 30 wt % and 65 wt % of the chocolate product.

2. A chocolate product according to claim 1, wherein the polyol is selected from the group comprising isomalt, sorbitol, maltitol, mannitol, xylitol, erythritol, threitiol, arabitol, lactitol, galactitol and hydrogenated starch hydrolysates and mixtures thereof.

3. A chocolate product according to claim 1, wherein the chocolate product comprises between 5 wt % and 22 wt % of the milk product.

4. A chocolate product according to claim 1, wherein the chocolate product comprises between 41 wt % and 56 wt % of the polyol.

5. A chocolate product according to claim 1, wherein from 0 wt % to 15 wt % of the total carbohydrates in the mixture is lactose.

6. A chocolate product according to claim 1, wherein the carbohydrate mixture is a composition expressed as dry matter percentage by weight of the mixture:
a. Lactose 0-40%;
b. Glucose 0-40%;
c. Galactose 0-40%; and
d. Galactooligosaccharides 10-80%.

7. A chocolate product according to claim 1, wherein the carbohydrate mixture is a composition expressed as dry matter percentage by weight of the mixture:
a. Lactose 3-20%;
b. Glucose 10-30%;
c. Galactose 1-10%; and
d. Galactooligosaccharides 45-70%.

8. A chocolate product according to claim 1, wherein the total sugar content is below 10 wt % of the chocolate product.

9. A chocolate product according to claim 1, wherein the milk product comprises greater than 20 wt % and less than 60 wt % of the carbohydrate mixture by weight of the milk product and the remainder of the milk product is non-carbohydrate milk solids.

10. A chocolate product according to claim 1, comprising:
comprising a milk product in an amount of between 5 wt % and 40 wt %, and
the milk product comprises between 30 wt % and 70 wt % based on the weight of the milk product of the carbohydrate mixture, and the carbohydrate mixture comprises between 20 wt % and 80 wt % galactooligosaccharide.

11. A chocolate product according to claim 1, wherein the polyol is maltitol.

12. A chocolate product according to claim 1, comprising:
a milk product comprising a carbohydrate mixture in an amount of between 10 wt % and 90 wt % of the milk product,
the milk product is present in an amount of between 0.5 wt % and 50 wt % of the chocolate product,
wherein the amount of carbohydrate mixture in the milk product and the amount of milk product in the chocolate product are selected so that the carbohydrate mixture is present in an amount of between 0.45 wt % and 35 wt % of the chocolate product, and
the carbohydrate mixture comprises galactooligosaccharides in an amount of 10-100 wt %, of the carbohydrate mixture.

13. A chocolate product according to claim 1, wherein the chocolate product is a milk chocolate or a white chocolate or compound.

14. A process for preparing the chocolate product comprising the steps of:
(a) providing a milk substrate comprising a total solids content of between 40 wt % and 75 wt %, preferably wherein the milk substrate comprises at least 15 wt % lactose based on a dry solids content;
(b) treating the milk substrate with an enzyme having transglycosylation activity, and
(c) fully or partially inactivating the enzyme.

15. The process of claim 14, wherein a solution prepared in step (b) or (c) is dried to provide a solid for combination with other ingredients of the chocolate product.
